(19) United States
(12) Patent Application Publication
(10) Pub. No.: US 2025/0234843 A1
(43) Pub. Date: Jul. 24, 2025

(54) COLORFUL ANIMAL STIMULATORY ENRICHMENT, NESTING, AND LITTER PRODUCT

(71) Applicant: The Andersons Inc., Maumee, OH (US)

(72) Inventors: Norman A. Peiffer, Maumee, OH (US); Edward L. Sharek, Maumee, OH (US)

(73) Assignee: The Andersons Inc., Maumee, OH (US)

(21) Appl. No.: 19/023,757

(22) Filed: Jan. 16, 2025

Related U.S. Application Data
(60) Provisional application No. 63/622,704, filed on Jan. 19, 2024.

(51) Int. Cl. A01K 15/02; G01N 21/80

(52) U.S. Cl. CPC A01K 15/025; G01N 21/80

(57) ABSTRACT

An animal product is provided that includes a plurality of colorful absorbent strips that form a puck. The plies can include at least one ply of fibrous material. In some inventive embodiments, the colorful absorbent strips have a height to length ratio from about 1:1 to about 1:200. While in other inventive embodiments, the adjuvants operative to enhance performance of said puck or entertainment value of said puck for a laboratory animal. The puck is amenable to radiation sterilized.

### RELATED APPLICATIONS

This application claims priority benefit of U.S. Provisional Application Ser. No. 63/622,704 filed Jan. 19, 2024; the contents of which are hereby incorporated by reference.

### FIELD OF THE INVENTION

The present invention in general relates to animal products, and in particular to a puck formed from colorful compressed paper strips, the unfolding of which providing an animal with a degree of mental stimulation, nest building material for thermoregulation, and a cage lining bedding material for the absorption of waste.

### BACKGROUND OF THE INVENTION

There is a growing body of evidence that domesticated animals, such as pets, and in particular laboratory animals exhibit behaviors that in humans are associated with sensory deprivation, and depression. These abnormal behaviors not only impact the well-being of an individual animal but also have implications in studies involving such an animal owing to the physiological effects of sensory deprivation and depression. In humans, sensory deprivation and depression have an effect on metabolism, cognitive function, immune response and other parameters relevant to clinical studies. The ability to provide a laboratory animal with a degree of mental stimulation is hampered by the requirements of study protocols that attempt to avoid introduction of new reaction variables, as well as the requirement in many instances that only sterilized materials be brought into contact with a laboratory animal. Captive animals deserve an environment which is rich in social opportunity, mental stimulation, and physical challenges. Sterility conditions are typically enforced in instances where an animal has been immunocompromised or otherwise carries a genetic defect rendering an animal vulnerable to disease or infection.

Enrichment and nesting materials provided to laboratory animals facilitate activities and purpose for the animals. Enrichment materials illustratively include toys, tunnels formed of cardboard or plastic materials, chipboard, molded pulp fiber habitats, cardboard enclosures, gnawing blocks, exercise equipment, litter, and nesting materials. Examples of nesting materials illustratively include aspen shavings, cotton squares, rolled paper and pellets, paper strips, and a puck formed from compressed paper strips as disclosed in U.S. Pat. No. 9,398,757; to The Andersons, Inc., and is incorporated herein by reference in its entirety. Enrichment materials encourage wild and domestic animals, including those in laboratory settings and pets, to exhibit their natural instincts to produce or seek shelter and provide the animals with a degree of control over their environment. Such animals include, but are not limited to, burrowing and non-burrowing rodents, birds, ferrets, weasels, rabbits, and marsupials. These positive behaviors lead to improved brain and neuronal development and reduce undesirable traits and behaviors in the animals including aggressive behavior and fighting, stereotypies, and barbering. Stereotypies are repetitive movements or sounds, and in lab animals typically include simple movements such as body-rocking and head-nodding, or more complex movements, such as pacing. Barbering is defined as abnormal whisker and fur plucking behavior commonly seen in mice and is thought to be associated with an expression of social dominance.

With laboratory study requirements, there are a limited number of opportunities to provide a source of stimulation to a confined laboratory animal. Prior art attempts have been made to include folded squares of paper with the intention that the animal would occupy time delaminating and chewing or unfolding the small chips of paper. Unfortunately, such attempts met with limited success. The 1985 amendments to the Animal Welfare Act included provisions for the promotion of the psychological well-being of nonhuman primates and for exercise for dogs. Today, many research, teaching, and testing facilities have established environmental enrichment programs for all animal species. (awic.nal.usda.gov/nal_display/index) are representative of this effort.

Nest building is a natural activity of rodents, especially mice. Nest building is a form of psychological enrichment and a vital part of needs for a mouse environment. Such burrowing rodents prefer loose materials to build their nests. Mice tend to be most comfortable at a temperature of 30 degrees Celsius. Often laboratories housing mice are maintained at a temperature of 21 to 24 degrees Celsius. Mice build nests in order to thermoregulate. Through the maintenance of mice at a comfortable temperature, mice consume less food, have higher pup yields, and experience less overall stress.

While there have been many advancements in enrichment materials and improvements for the quality of living conditions for laboratory animals there continues to be a need for further efficiencies in laboratory set up for animals that also provide for improvements in the well-being of the animals, as well as efficient distribution to animal cages and usage of materials. Such efficiencies also offer benefits for pets in a home setting, allowing for faster and easier cage set up after cleaning and improvements for the quality of living conditions for such pets.

Additionally, it has been shown that domesticated animals, including those who reside in pens and cages such as small animal pets or as laboratory test subjects, benefit emotionally from human interaction. It has also been shown that different colors stimulate various emotional and behavioral responses in both humans and animals.

Thus, there exists a need for a colorful animal enrichment, nesting, and litter product that engages the attention of a domesticated or laboratory animal to occupy time and alleviate some of the symptoms associated with sensory deprivation and thermal dysregulation while also providing aesthetic appeal and stimulating emotional and behavioral responses in the human caretaker. There further exists a need for such an enrichment, nesting, and litter product capable of being sterilized and still functioning as an effective animal litter product.

### SUMMARY OF THE INVENTION

An animal product is provided that includes a plurality of colorful absorbent strips that form a puck. The plies can include at least one ply of fibrous material. In some inventive embodiments, the colorful absorbent strips have a height to length ratio from about 1:1 to about 1:200. While in other inventive embodiments, the adjuvants operative to enhance performance of said puck or entertainment value of said puck for a laboratory animal. The puck is amenable to radiation sterilized.

### BRIEF DESCRIPTION OF THE DRAWINGS

The application file contains at least one drawing executed in color. Copies of this patent application publication with color drawings will be provided by the Office upon request and payment of the necessary fee.

FIG. 1 is a perspective view of strip material used in forming a puck of the present invention;

FIG. 2 is a perspective view a puck formed from compressed strip material of FIG. 1 according to an embodiment invention; and

FIG. 3 is a perspective representation of laboratory animal manipulation of the inventive puck.

FIGS. 4A and 4B are different inventive pucks that vary in being heterogeneous (FIG. 4A) and homogenous (FIG. 4B) in color distribution.

### DESCRIPTION OF THE INVENTION

The present invention has utility as a colorful animal litter and nesting product that engages the attention of a domesticated or laboratory animal to occupy time and alleviate some of the symptoms associated with sensory deprivation and thermal dysregulation while also providing aesthetic appeal and stimulating emotional and behavioral responses—from the human caretaker. The present invention additionally has utility as a litter capable of being sterilized and still functioning as an effective animal litter product. The litter material is provided in the form of a puck formed from compressed paper strips, the unfolding of which provides an animal with a degree of mental stimulation and nest construction and litter material for absorbing urine and waste. It has been surprisingly found that a compressed mass according to the present invention provides multiple benefits to the animal including mental stimulation and activity generation, nesting material, and also improved thermal regulation. Additionally, the colorful nature of the animal litter product provides not only an aesthetic appeal for the human caretaker, but also provides utility as an information indicator such as a color-coding system or an indication of the status of the litter as fresh or spent. Using the psychology of color, the colorful nature of the product additionally stimulates emotional and behavioral responses from the human caretaker that lead to increased and more positive interactions with the animal, thereby improving the well-being of the animal. Additionally, the pre-measured quantum of material in an inventive product affords a benefit to the caregiver in that the product is simply placed in the cage without resort to measuring and thereby saving time and precluding spillage of separated materials. With the animal occupied and thermally regulated, it is noted that animal food consumption and health are generally improved. The present invention is particularly beneficial to rodents and especially mice.

The deconstruction of the puck by an animal into constituent strip components provides the animal with an activity that occupies time and appears to alleviate behaviors associated with cage confinement while also providing entertainment and enjoyment for a caretaker when observing the animal during the deconstruction and nesting process. Strip materials illustratively include paper strip material, wood cotton, bamboo, and other cellulosics. The resultant decompressed strips are routinely fashioned into nesting material by animals. In addition, the animal is able to push or carry the puck to different areas of the cage. In an instance where more than one puck is introduced to the animal's environment, the animal can collect the pucks or distribute the pucks around their cage.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein, the term “strip” is defined to include at least one ply of fibrous material. The fibrous material illustratively includes cellulose, alkoxylated cellulose, alginate, starch, polyethylene, polypropylene, polyvinyl, polystyrene, elastane, rubber, fleece, cellulose pulp, cellulose pulp derivatives, or any combinations thereof. The strips being planar, crinkled, twisted, rolls, and combinations thereof.

As used herein, an “animal” is defined to include a burrowing and non-burrowing rodent such as a mouse, rat, hamster, gerbil, and rabbit; a ferret; a weasel; a marsupial; a bird such as a quail, chicken, turkey, parrot, parakeet, canary, and finch: felines, such as domesticated cats; and a primate such as a monkey, chimpanzee, and gorilla.

Strip material used in embodiments of the invention illustratively include colorful materials including paper strips, crinkled paper strips, paper shreds, rolled paper strips, materials that form pellets, a puck, or an amorphous mass. The strip material in some embodiments is amenable to usage as a nesting material and is illustratively formed from compressed paper strips, cellulosic fluff, cotton fiber, crinkle paper, wood strips, wood chips, and shavings; natural materials such as cotton nestlets, or combinations thereof. It is observed that the unfolding or other manipulation of the strip material provides an animal with a degree of mental stimulation and nest construction. It has been surprisingly found that a compressed mass provides multiple benefits to the animal including mental stimulation and activity generation, nesting material, and also improved temperature regulation. Additionally, the pre-measured quantum of material in an inventive product affords a benefit to the caregiver in that the product is simply placed in the cage without resort to measuring and thereby saving time and precluding spillage of separated materials. The colorful material additionally increases caretaker interactions with the caged animal for both play and cleaning of the environment, owing in part to the customization of cage decor and the ease with which the litter material may be replaced. With the animal occupied and thermally regulated, it is noted that animal food consumption and health are generally improved. The present invention is particularly beneficial to rodents and especially mice. In still other embodiments, food is placed within the strip material, alone or in combination with nesting material. It has been observed that burrowing into the strip material to find foodstuffs also affords a caged animal a degree of mental stimulation and activity that is lacking in a conventional feeding tray.

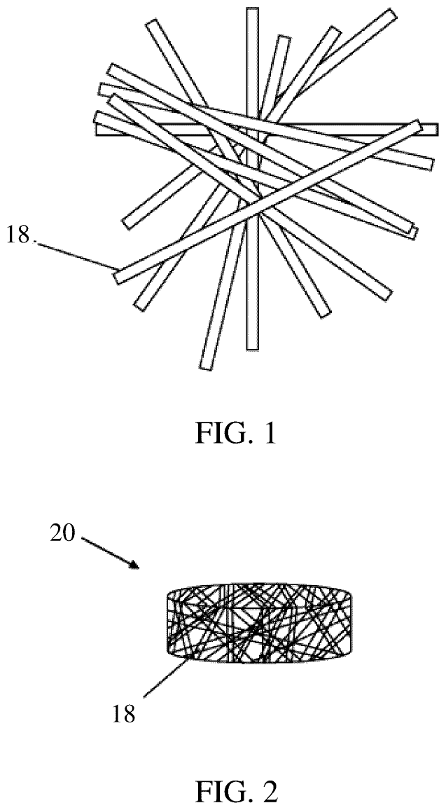

FIG. 1 illustrates a group or pile of strips 18 that may be provided loose as nesting material, or that are compressed to form the puck 20 as depicted in FIG. 2, and as disclosed in U.S. Pat. No. 9,398,757. The strips 18 may have a height to length ratio from 1:1 to 1:200; and in still other embodiments from 1:5 to 1:50 with the understanding that other height to length ratios depending on the overall dimensions of the puck 20 are operative herein. It is appreciated that the term “puck” includes shapes other than right cylinders and also include rectilinear forms, spheroids, polygonal forms, and geometrically irregular forms. The puck can have smooth or frayed edges. The thickness of the strips 18 may typically be between 0.07 millimeters (0.0028 in) and 0.18 millimeters (0.0071 in). It is also appreciated that according to the present invention, depending on the size of the animal, the thickness of the strip 18 is increased beyond these values.

The strips 18 are in certain embodiments amenable to sterilization for use in conjunction with immuno-compromised or genetically mutated laboratory animal models for disease. The sterilization techniques operative with the paper strip component of a puck 20 illustratively include gamma radiation, including from a cobalt-60 source and thermal sterilization techniques such as those involving superheated steam or heated air.

The strips 18 of the inventive puck 20 are amenable to incorporation of various adjuvants operative to enhance performance and/or entertainment value of the puck 20. Adjuvants suitably incorporated into the strip material 18 illustratively include fragrances; dyes; odor suppressants such as baking soda; superabsorbent polymer granules; flavorants such as sugar and fruit flavors; and nutrients. In the instance where a strip 18 component includes entertainment value enhancing adjuvants such as dyes or flavorants, it is appreciated that the stimulation value is enhanced by irregular distribution of the adjuvant. Irregular distribution is readily achieved by exposing the pile of strip material 18 for an amount of time sufficient to create an incomplete penetration of the adjuvant into the strip material 18. It is appreciated that an adjuvant is readily applied in the form of a solid, liquid, or solution with excess moisture being removed to arrive at a strip 18 component moisture component with a preselected level.

The puck 20 is formed by compressing a pile of strip material 18 in a compression mold. As shown in FIG. 1, the pile of strip material 18 is composed of a randomized material, which when compressed form the puck 20 of randomly oriented and intertwined strips 18. To aid in the forming and retention of the puck shape during and after the release from the mold, the strip material 18 may be wetted with water or other alternative liquids.

In certain inventive embodiments, the puck 20 has a mean height between 25.4 millimeters (0.1 in) and 254 millimeters (1.0 in). The diameter of the puck 20 may vary, for example between 127 millimeters (0.5 in) and 508 millimeters (2.0 in), with a typical ratio between diameter and height of between 2:1 and 30:1. It is appreciated that the mean height and diameter of the puck 20 is chosen with recognition as to the size and dexterity of the animal using the inventive puck 20, as well as the dimensions of an enclosure in which the puck 20 is to be placed. For example, much larger dimensions would be required for a puck for use with larger mammals than rodents.

An animal, when provided with the puck 20, engages in an activity to reduce boredom, anxiety, and stress; as well experiencing enhanced mental stimulation. An animal is also noted to have better thermal regulation upon deconstruction of a puck 20 into constituent strips of strip material 18 and therefore have lower overall food consumption. The activity involves relocation of one or more supplied pucks 20 and systematic turning and unfolding of the pucks 20 to yield individual paper strips 18. The deconstructed strips 18 then serve as a litter material to absorb animal urine and waste as the strips 18 are spread over the area of the cage.

An inventive puck is easily placed within the cage of an animal by a caretaker. The pucks 20 are provided in a variety of color options and are preformed so that strip material 18 is not scattered and wasted as the caretaker places the puck 20 within the cage. The caretaker is able to customize the decor within the cage based on a selected puck color. According to embodiments, the strip material 18 is available in a variety of colors and shades. For example, the strip material 18 is available in any Pantone Matching System color, including but not limited to, brown, kraft, white, black, natural, ivory, green, lime green, navy blue, red, royal blue, light pink, orchid, French vanilla, canary, yellow, orange, mint green, teal, burgundy, lavender, purple, light blue, olive green, cognac, forest green, chocolate, slate gray, sky blue, gold, silver, etc. The strip material 18 is also available is color combinations representative of various seasons, holidays, sports teams, schools, etc. According to embodiments, the strips 18 are provided in a neon color to provide a glow to the cage environment. A caretaker can even make a personalized color combination by utilizing multiple pucks 20 of different colors. This allows a caretaker to customize the decor within the animal's cage, making it more enjoyable to replace the animal litter and making it more aesthetically pleasing to view the animal enclosure on a day-to-day basis. The colors used in the cage can also affect emotional and behavioral responses of the caretaker using color psychology. That is, different colors evoke different emotional and behavioral responses in humans. For example, colors in the red area of the color spectrum are known as warm colors and include red, orange, and yellow. These warm colors evoke emotions ranging from feelings of warmth and comfort to feelings of anger and hostility. Colors on the blue side of the spectrum are known as cool colors and include blue, purple, and green. These colors are often described as calm, but can also call to mind feelings of sadness or indifference. One 2020 study that surveyed the emotional associations of 4,598 people from 30 different countries found that people commonly associate certain colors with specific emotions, as noted below:
Black: 51% of respondents associated black with sadness
White: 43% of people associated white with relief
Red: 68% associated red with love
Blue: 35% linked blue to feelings of relief
Green: 39% linked green to contentment
Yellow: 52% felt that yellow means joy
Purple: 25% reported they associated purple with pleasure
Brown: 36% linked brown to disgust
Orange: 44% associated orange with joy
Pink: 50% linked pink with love

Researchers have attributed similar color responses to animals, subject to species specific color spectrum visual detection. Accordingly, the strip material 18 of the present invention is provided in a variety of colors. Depending on the color chosen, the decorated cage can invoke a variety of emotions for the caretaker and/or other humans sharing the environment with the animal cage.

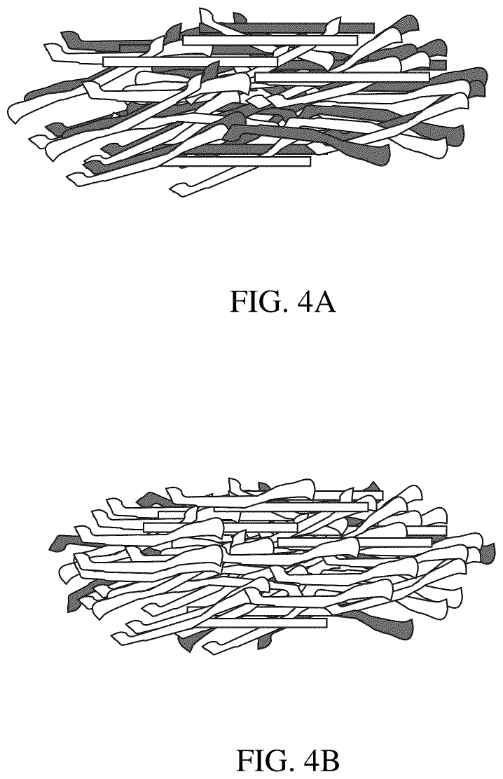

According to some inventive embodiments, the colored strip material 18 acts as an information indicator such as a color-coding system. That is, providing the pucks 20 in a variety of colors allows for a simple and readily apparent visual indicator of a particular meaning. For example, in a laboratory setting a control group of animal cages may be outfitted with pucks in a first color, such as blue, while the test group of animal cages is outfitted with pucks in a second different color, such as red, in order to clearly distinguish the groups; or in an alternative example, the strips of a first color are present on one planar surface, as shown in FIG. 4A, while a second color is visible on the opposing side for a control group, while homogenous mixed strips of the first color and second color are used, as shown in FIG. 4B, for the test group. As a result, one additional visual cue is provided to an attendant as to group association of a given cage. Embodiments As another example, pucks of different colors can be used in various settings such as laboratories, veterinary offices, and animal daycare and boarding facilities to indicate different information such as specialized diets or care needs. Such a clear visual indicator of information at the exact location of the animal housed in the cage aids in ensuring that the information is not easily overlooked.

According to other inventive embodiments, the colored strip material 18 acts as an indication of the status of the litter as fresh or spent. That is, according to still other inventive embodiments, the strip material 18 exhibits a color change when it has been wetted with animal urine or waste, thereby providing a clear visual indicator that the litter is spent. When a majority of the strip material 18 displays the changed color, it is a clear indicator to the caretaker that the spent litter should be removed from the cage and replaced with a fresh puck 20. According to other inventive embodiments, the strip material 18 for indicating the status of the litter is simply a light colored material that changes to a darker shade upon becoming wet. For example, a strip material 18 that is light blue when fresh and dry may turn a darker shade of blue when wetted. According to still other inventive embodiments, the strip material 18 includes an additive indicator that changes color based on the pH level of the wetting substance. For example, the strip material 18 may be yellow when fresh and dry and subsequently turn blue when wetted.

According to other inventive embodiments, the strip material 18 is provided with erythrosine—a common food dye, which here is used as a photosensitizer to produce singlet oxygen for virus inactivation and to indicate the completion of water disinfection through photobleaching color change in an enhanced solar disinfection (SODIS) process.

In still other inventive embodiments, a binder is provided to retain the strip material 18 adhered to other strips to better retain the form of the puck. Binders operative herein are limited only by the requirements of providing tack to join contracting strips together and also to be compatible with usage by the animal. Binders operative herein illustratively include white glue, carpenter's glue, guar gum, xanthan gum, pectin, gelatin, lignosulfonates, albumin, mucilage, other carbohydrate-based glues, other protein-based glues, and combinations thereof.

An animal exposed to a puck 20, in particular a rodent, is observed to initially begin chewing the puck 20. Upon the animal discovering that the puck 20 begins to unravel into strips 18, animal handling and chewing of a puck 20 becomes purposeful with the intent of rendering a puck 20 as a collection of strips 18. The strips 18 formed from unfolding the one or more pucks 20 are then taken by the animal to be used to form a hiding place as well as bedding, especially within an enclosure. The strips 18 then act as an absorbent material for urine and waste, thereby helping to maintain hygienic conditions within the enclosure.

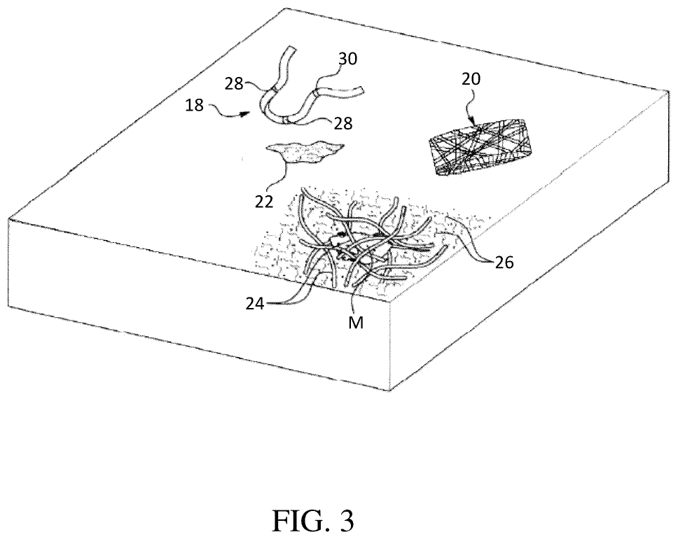

As shown with reference to FIG. 3, the inventive puck 20, as provided to an animal, contains strip material 18. An animal, such as a mouse M, as depicted in FIG. 3, begins to interact with the inventive puck 20 or strip material 18. The animal M chews thus produces a macerated polymeric mass 22. Typically, the animal M begins to unravel pucks to form partially unraveled strips from the puck 20 or strip material 18, and eventually succeeds in creating only unraveled strip material 18. The strip material 18, partially unraveled puck 20 and macerated mass 22 in varying amounts are formed as a shelter 24 and/or a bedding mass 26. A surprising aspect of the present invention is that male rodents, which are more likely to exhibit abhorrent and antisocial behavior, are also observed to engage in apparent play behavior with the strip material 18 of a puck 20. The periodic inclusion of flavorant patches 28 and to a lesser extent colorimetric zones 30 along the length of a paper strip 12 is noted to enhance animal interest in the inventive puck.

An inventive puck is also amenable to usage with a structure as detailed in U.S. Provisional Application Ser. No. 63/607,606 filed Dec. 8, 2023 to the same applicant; the contents of which are hereby incorporated by reference.

The present invention is further illustrated through resort to the following non-limiting examples. These examples are not intended to limit the scope of the appended claims.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. An animal product, said product comprising:
a plurality of colorful absorbent strips forming a puck.

2. The animal product of claim 1 wherein said plurality of colorful absorbent strips comprise at least one ply of fibrous material.

3. The animal product of claim 2 wherein said fibrous material includes cellulose, alkoxylated cellulose, alginate, starch, polyethylene, polypropylene, polyvinyl, polystyrene, elastane, rubber, fleece, cellulose pulp, cellulose derivatives, or any combinations thereof.

4. The animal product of claim 1 wherein said plurality of colorful absorbent strips have a height to length ratio from about 1:1 to about 1:200.

5. The animal product of claim 1 wherein said plurality of colorful absorbent strips have a thickness between 0.07 millimeters (0.0028 in) and 0.18 millimeters (0.0071 in).

6. The animal product of claim 1 wherein said plurality of colorful absorbent strips are subjected to sterilization.

7. The animal product of claim 1 wherein said plurality of colorful absorbent strips include adjuvants operative to enhance performance of said puck or entertainment value of said puck for a laboratory animal.

8. The animal product of claim 7 wherein said adjuvants comprise fragrances, dyes, odor suppressants, superabsorbent polymer granules, and flavorants.

9. The animal product of claim 7 wherein said adjuvants have an irregular distribution in said puck.

10. The animal product of claim 1 wherein said plurality of colorful absorbent strips comprises at least two types of strips from planar, crinkled, twisted, or rolled.

11. The animal product of claim 1 wherein said puck has a mean height from about 25.4 millimeters (0.1 in) to about 254 millimeters (1.0 in), and a diameter of about 127 millimeters (0.5 in) to about 508 millimeters (2.0 in).

12. The animal product of claim 1 wherein said puck has a diameter to height ratio from about 2:1 to about 30:1.

13. The animal product of claim 1 wherein said puck is radiation sterilized.

14. The animal product of claim 1 wherein said puck is formed from the compression of said plurality of colorful absorbent strips in a mold.

15. The animal product of claim 1 wherein each of said plurality of colorful absorbent strips is provided in any Pantone Matching System color, including brown, white, black, natural, ivory, green, lime green, navy blue, red, royal blue, light pink, orchid, French vanilla, canary, yellow, orange, mint green, teal, burgundy, lavender, purple, light blue, olive green, cognac, forest green, chocolate, slate gray, sky blue, gold, silver, or a combination thereof.

16. The animal product of claim 1 wherein at least one of said plurality of colorful absorbent strips change color when wetted.

17. The animal product of claim 1 wherein at least one of said plurality of colorful absorbent strips contain erythrosine.

18. The animal product of claim 1 wherein at least one of said plurality of colorful absorbent strips include an additive indicator that changes color based on pH level.

19. The animal product of claim 1 wherein said puck induces extended play time in a caged animal by providing the animal the opportunity to relocate and disassemble said puck into said plurality of colorful absorbent strips and wherein a color of said plurality of colorful absorbent strips is configured to convey information to a caretaker of the caged animal.

20. The animal product of claim 1 further comprising a binder retaining said plurality of colorful absorbent strips in the form of said puck.
